(19) United States
(12) Patent Application Publication
(10) Pub. No.: US 2011/0314956 A1
(43) Pub. Date: Dec. 29, 2011

(54) Assembly and Welding Method for Coupling a Rotor to the Shaft of a Pedal Assembly

(76) Inventors: Andrew Campbell, East Kilbride (GB); Willie Campbell, Bathgate (GB)

(21) Appl. No.: 13/162,213

(22) Filed: Jun. 16, 2011

Related U.S. Application Data
(60) Provisional application No. 61/357,779, filed on Jun. 23, 2010.

(51) Int. Cl. G05G 1/44; B32B 37/16; G05G 1/50; F16B 11/00

(52) U.S. Cl. 74/560; 403/270; 156/293

(57) ABSTRACT

An assembly and method for coupling the rotor of a vehicle pedal assembly to the shaft of a vehicle pedal assembly. In one embodiment, the rotor includes a collar with an interior surface defining a plurality of slots and the shaft includes a distal neck which extends into the collar of the rotor. A weld horn is inserted into the collar and into contact with the neck of the shaft for melting a portion of the neck and causing the material of the molten neck to flow into the slots for securing the rotor to the shaft.

### CROSS-REFERENCE TO RELATED APPLICATIONS

This application claims the benefit of the filing date and disclosure of U.S. Provisional Patent Application Ser. No. 61/357,779 filed on Jun. 23, 2010, the entire disclosure of which is explicitly incorporated herein by reference as are all references cited therein.

### FIELD OF THE INVENTION

This invention relates generally to a pedal assembly and, more specifically, to an assembly and welding method for coupling and securing a rotor to the shaft of a pedal assembly.

### BACKGROUND OF THE INVENTION

Vehicle pedal assemblies of the type disclosed in, for example, United States Patent Application Publication No. 2007/0137400 A1 include, among other elements, a pedal housing, a pedal extending into and supported in the pedal housing, a metal shaft extending through the pedal and coupling the pedal for rotation relative to the pedal housing, and a plastic sensor rotor mounted to a distal end of the shaft for rotation with the shaft in response to the rotation of the pedal.

Currently, the rotor is secured to the distal end of the shaft either by press fitting the metal shaft to the plastic rotor or, alternatively, the metal shaft includes slots which are splayed open to retain the rotor on the shaft.

A disadvantage associated with the above rotor to shaft coupling structures however is that they are not applicable where both the shaft and the rotor are made of the same or similar materials such as plastic.

The present invention is directed to a simple, inexpensive, and robust assembly and method for coupling and securing a plastic rotor to a plastic shaft and, more specifically, to an assembly and method for coupling a plastic sensor assembly rotor to the plastic shaft of a vehicle pedal assembly.

### SUMMARY OF THE INVENTION

The present invention is directed generally to a vehicle pedal assembly which comprises a pedal, a shaft extending through the pedal and defining a distal end, and a rotor mounted to the distal end of the shaft, the rotor defining at least one interior slot and a portion of the material defining the shaft extends into the at least one interior slot defined in the rotor for securing the rotor to the shaft.

In one embodiment, the rotor defines a plurality of spaced-apart slots and a portion of the material defining the shaft extends into the plurality of slots.

In one embodiment, the rotor includes a collar including an interior surface defining an interior aperture, the interior surface of the collar defines the plurality of spaced-apart slots, the distal end of the shaft includes a neck which extends through the aperture of the collar of the rotor and the material of the neck of the shaft extends into the plurality of slots respectively for securing the rotor to the shaft.

In one embodiment, each of the slots defined in the interior surface of the collar includes a tapered back wall and a pair of opposed side walls, and the material of the neck of the shaft abuts against the back wall and the opposed side walls of each of the plurality of slots respectively.

In one embodiment, the material defining the shaft is melted into the plurality of slots defined in the rotor.

The present invention is also directed to an assembly for coupling a rotor to a shaft which comprises a shaft and a rotor having an interior surface which defines a plurality of slots, and the material of the shaft extends into the plurality of slots defined in the interior surface of the rotor to secure the rotor to the shaft.

In one embodiment, each of the slots defined in the interior surface of the rotor includes a tapered back wall and opposed side walls, and the material of the shaft abuts against the back wall and the opposed side walls of each of the plurality of slots respectively.

In one embodiment, the rotor includes a collar, the interior surface and the plurality of slots are defined in the collar, and the shaft includes a neck which extends into the interior surface of the collar of the rotor.

In one embodiment, the material of the shaft is melted into the plurality of slots defined in the interior surface of the rotor.

The present invention is further directed to a method of securing a rotor to a shaft which comprises the steps of providing a shaft, providing a rotor defining a plurality of interior slots, mounting the rotor to the shaft, and melting the material of the shaft into the plurality of slots defined in the rotor for securing the rotor to the shaft.

In one embodiment, the shaft includes a neck and the rotor includes a collar, and the plurality of slots is defined in the collar of the rotor and the neck of the shaft extending into the collar of the rotor.

Other advantages and features of the present invention will be more readily apparent from the following detailed description of the preferred embodiment of the invention, the accompanying drawings, and the appended claims.

### BRIEF DESCRIPTION OF THE DRAWINGS

In the accompanying drawings that form part of the specification, and in which like numerals are employed to designate like parts throughout the same:

FIG. 1 is an enlarged, broken, exploded perspective view of a shaft in accordance with the present invention prior to the insertion thereof into a pedal;

FIG. 2 is an enlarged, perspective view of a rotor in accordance with the present invention;

FIG. 3 is an enlarged, broken, part perspective view, part vertical cross-sectional view depicting the rotor shown in FIG. 2 fitted over the distal end of the shaft shown in FIG. 1 and prior to the melting and welding of the shaft material into the rotor;

FIG. 4 is an enlarged, broken, part perspective view, part vertical cross-sectional view depicting a weld horn inserted into the collar of the rotor and in contact with the neck of the shaft for melting and welding the shaft material into the slots defined in the collar of the rotor; and

FIG. 5 is an enlarged, broken, part perspective view, part vertical cross-sectional view depicting the rotor and the shaft of the present invention in their coupled relationship following the melting and welding of the shaft material into the slots defined in the collar of the rotor.

### DETAILED DESCRIPTION OF THE EMBODIMENT

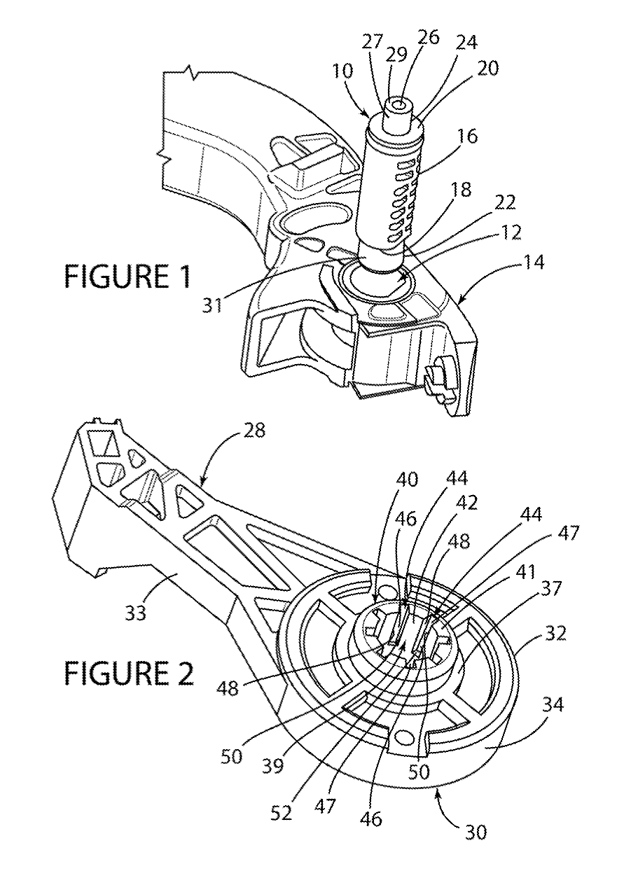

FIG. 1 depicts a shaft 10 in accordance with the present invention which is adapted for insertion and press fitting into the through-hole 12 of a pedal 14 of a vehicle pedal assembly (not shown) of the type disclosed in, for example, United States Patent Application Publication No. US 2007/0137400 A1, the description of which is incorporated herein by reference.

In accordance with the present invention and as shown in FIG. 1, the shaft 10 which, in the embodiment shown is made of plastic, includes an elongated, generally cylindrically-shaped central base 16 adapted to be interference fitted in the through-hole 12 of the pedal 14. The base 16 includes opposed distal radial end faces 18 and 20 (FIG. 1), each including a respective generally cylindrically-shaped neck 22 and 24 projecting outwardly therefrom. Each of the necks 22 and 24 has a diameter less than the diameter of the base 16. Additionally, in the embodiment shown, the diameter of the neck 22 is greater than the diameter of the neck 24.

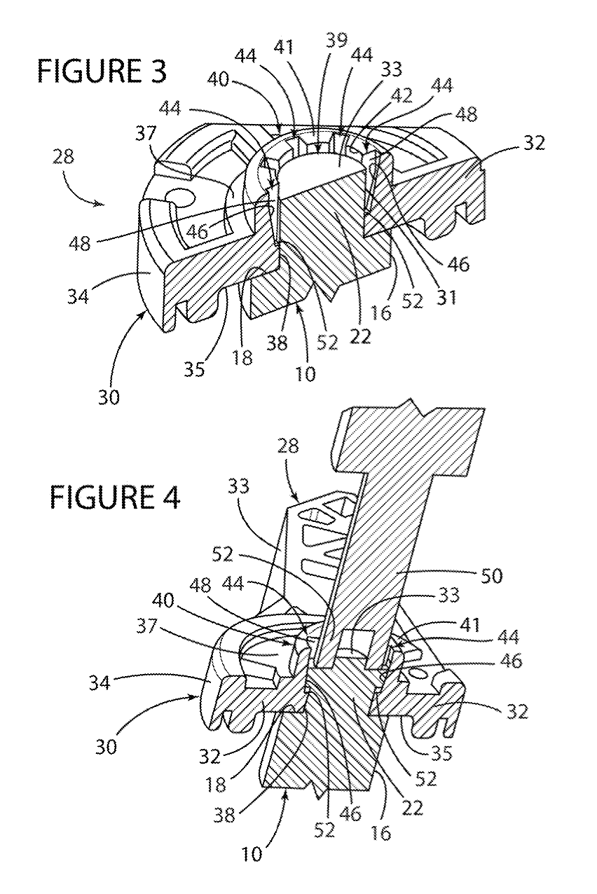

As shown in FIG. 1, the neck 24 includes a central, generally cylindrically-shaped interior surface defining an elongated generally cylindrically-shaped recess 26 extending centrally through the interior of the neck 24, an exterior circumferential surface 27, and a top peripheral radial end face 29. The neck 22 includes an exterior circumferential surface 31 (FIGS. 1 and 3) and a top peripheral radial end face 33 (FIGS. 3 and 4).

FIGS. 2, 3, 4, and 5 depict a rotor 28 in accordance with the present invention. The rotor 28, which in the embodiment shown is also made of plastic, includes a generally circular base 30 in the form of a cap including a generally circular plate 32 and a circumferentially extending side wall 34 projecting generally normally outwardly from a peripheral edge of the plate 32. An elongated sensor arm 33 (FIGS. 2 and 4) projects outwardly from the side wall 34 of the base 30 of the rotor 28.

The plate 32 in turn includes a central circumferentially extending interior surface 38 (FIGS. 3, 4, and 5). A circumferentially extending cylindrically-shaped collar 40 (FIGS. 2, 3, 4, and 5) projects unitarily outwardly from a portion of the top surface 37 of the plate 32 surrounding the opening defined in the top surface 37 by the interior surface 38. The collar 40 extends and projects unitarily outwardly from the top surface 37 of the plate 32 in a direction opposite the side wall 34 which extends and projects outwardly from the peripheral edge of the plate 32.

The collar 40 includes a top peripheral circumferentially extending radial end face 41 and a circumferentially extending interior surface 42 extending in a direction generally normal to the peripheral end face 41 (FIGS. 2, 3, 4, and 5).

The interior surface 42 in the collar 40 and the interior surface 38 in the plate 32 are co-linearly aligned and together define a central through-aperture 39 (FIGS. 2 and 3) extending through the base 30 of the rotor 28. The circumferentially extending interior surface 42 of the collar 40 and a portion of the interior surface 38 of the plate 32 of the rotor 28 together include and define a plurality of spaced-apart elongated slots or recesses 44. In the embodiment shown, the slots 44 are positioned relative to each other in a parallel relationship and extend around the circumference of the respective interior surfaces 42 and 38 of the collar 40 and the plate 32 in a relationship generally normal to the top peripheral end face 41 of the collar 40 and the top surface 37 of the plate 32 of the base 30 of the rotor 28 and in a relationship generally parallel to and spaced from the exterior circumferential surface of the collar 40.

Moreover, and referring to FIG. 2, each of the plurality of slots 44 (two of which have been identified in FIG. 2) defines an opening 47 in the top peripheral radial end face 41 of the collar 40; a flat, elongated back surface or face 46; a pair of opposed, parallel, and spaced-apart flat, generally vertical elongated side surfaces or faces 48 and 50; and a flat horizontal lower base 52 opposite and spaced from the opening 47. The back surface or face 46 of each of the slots 44 is angled and tapers inwardly between the opening 47 and the base 52 in the direction of the center of the collar 40. The base 52 is located in and defines a ledge or shoulder extending inwardly from the interior surface 38 of the plate 32 of the rotor 28.

The rotor 28 is mounted to the shaft 10 in a relationship wherein the cap/base 30 of the rotor 28 is mounted and fitted over the distal neck 22 of the shaft 10 and, more specifically, in a relationship wherein the interior/lower/bottom surface 35 (FIGS. 3, 4, and 5) of the plate 32 of the base/cap 30 of the rotor 28 is abutted against the radial end face 18 of the shaft 10; the distal neck 22 of the shaft 10 extends through the interior through-aperture 39 defined in the collar 40 and the base 30 of the rotor 28 in a relationship wherein the exterior surface 31 of the neck 22 of the shaft 10 is abutted against the interior surface 38 of the base 30 and the interior surface 42 of the collar 40 (FIG. 3); and the side wall 34 of the base/cap 30 of the rotor 28 surrounds and is spaced from the base 16 of the shaft 10.

According to the invention, and as shown in FIG. 4, an ultrasonic, or other suitable, weld horn 50 is adapted to be inserted into the interior of the collar 40 of the rotor 28 via the opening defined in the peripheral radial end face 41 thereof by the through-aperture 39 defined in the collar 40 into a relationship abutting the top peripheral radial end face 33 of the neck 22 of the shaft 10.

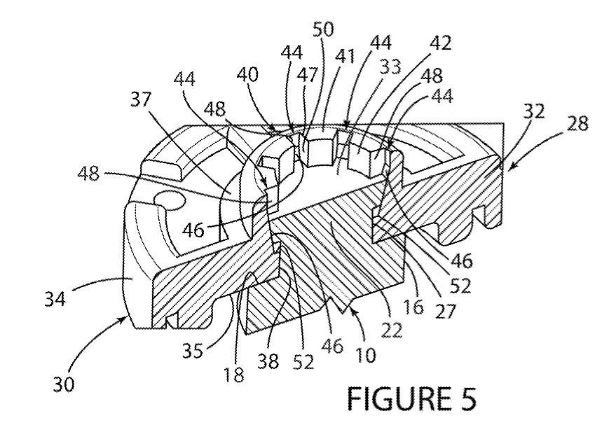

The weld horn 50 is subsequently activated to cause a portion of the plastic material of the neck 22 of the shaft 10 to melt and flow outwardly into each of the slots 44 defined in the interior surfaces 42 and 38 of the collar 40 and the base 30 respectively of the rotor 28 as shown in FIGS. 4 and 5 into a relationship wherein the material of the neck 22 of the shaft 10 fills each of the slots 44 and is abutted against at least the back wall 46 and the opposed side walls 48 and 50 of each of the slots 44 to weld and secure the rotor 28 to the shaft 10. The tapered back wall 46 of each of the slots 44 prevents the neck 22 and thus the shaft 10 from being pulled out of the collar 40 and the side walls 48 and 50 of each of the slots 44 prevent the neck 22 and thus the shaft 10 from rotating relative to the collar 40 and thus the rotor 28.

While the invention has been taught with specific reference to the embodiment shown, it is understood that a person of ordinary skill in the art will recognize that changes can be made in form and detail without departing from the spirit and the scope of the invention. The described embodiment is to be considered in all respects only as illustrative and not restrictive.

What is claimed is:

1. A vehicle pedal assembly comprising:
a pedal;
a shaft extending through the pedal and defining a distal end; and
a rotor mounted to the distal end of the shaft, the rotor defining at least one interior slot and a portion of the material defining the shaft extends into the at least one interior slot defined in the rotor for securing the rotor to the shaft.

2. The vehicle pedal assembly of claim 1, wherein the rotor defines a plurality of spaced-apart slots and a portion of the material defining the shaft extends into the plurality of slots.

3. The vehicle pedal assembly of claim 2, wherein the rotor includes a collar including an interior surface defining an interior aperture, the interior surface of the collar defining the plurality of spaced-apart slots, the distal end of the shaft including a neck extending through the aperture of the collar of the rotor and the material of the neck of the shaft extending into the plurality of slots for securing the rotor to the shaft.

4. The vehicle pedal assembly of claim 3, wherein each of the slots defined in the interior surface of the collar includes a tapered back wall and a pair of opposed side walls, the material of the neck of the shaft abutting against the back wall and the opposed side walls of each of the plurality of slots respectively.

5. The vehicle pedal assembly of claim 4, wherein the material defining the shaft is melted into the plurality of slots defined in the rotor.

6. The vehicle pedal assembly of claim 1, wherein the material defining the shaft is melted into the at least one interior slot defined in the rotor.

7. An assembly for coupling a rotor to a shaft comprising:
a shaft; and
a rotor having an interior surface defining a plurality of slots, the material of the shaft extending into the plurality of slots defined in the interior surface of the rotor for securing the rotor to the shaft.

8. The assembly of claim 7, wherein each of the slots defined in the interior surface of the rotor includes a tapered back wall and opposed side walls, the material of the shaft abutting against the back wall and the opposed side walls of each of the plurality of slots respectively.

9. The assembly of claim 7, wherein the rotor includes a collar, the interior surface and the plurality of slots being defined in the collar, the shaft including a neck extending into the interior surface of the collar of the rotor.

10. The assembly of claim 7, wherein the material of the shaft is melted into the plurality of slots defined in the interior surface of the rotor.

11. A method of securing a rotor to a shaft comprising the steps of:
providing a shaft;
providing a rotor defining a plurality of interior slots;
mounting the rotor to the shaft; and
melting the material of the shaft into the plurality of slots defined in the rotor for securing the rotor to the shaft.

12. The method of claim 11, wherein the shaft includes a neck and the rotor includes a collar, the plurality of slots being defined in the collar of the rotor and the neck of the shaft extending into the collar of the rotor.
